(19) United States
(12) Patent Application Publication
(10) Pub. No.: US 2023/0350140 A1
(43) Pub. Date: Nov. 2, 2023

(54) PHOTONIC CHIP, METHOD FOR ASSEMBLING AN OPTICAL PART AND SAID PHOTONIC CHIP, AND PHOTONIC COMPONENT RESULTING THEREFROM

(71) Applicant: Scintil Photonics, Grenoble Cedex 9 (FR)

(72) Inventor: Sylvie Menezo, Grenoble Cedex 9 (FR)

(21) Appl. No.: 18/002,086

(22) PCT Filed: Mar. 8, 2021
(86) PCT No.: PCT/FR2021/050386

§ 371 Date: Dec. 16, 2022

(30) Foreign Application Priority Data
Jun. 22, 2020 (FR) 2006481

(51) Int. Cl. G02B 6/42

(52) U.S. Cl. CPC G02B 6/4225; G02B 6/4214; G02B 6/4213

(57) ABSTRACT

A method is used for assembling an optical part and a photonic chip, the optical part comprising a plurality of optical pathways to be aligned with a plurality of input-output areas. The photonic chip comprises a light source, a photo detector and an alignment input-output. The optical part is provided with a reflector on at least one alignment pathway, and the photonic chip and the optical part are actively aligned relative to one other by exploiting the measurement of the signal provided by the photo detector of the chip using the optical power transmitted by the light source, reflected by the reflector and recoupled to the photo detector. The present disclosure also relates to the photonic chip and to a component comprising the chip joined to the optical part.

### CROSS-REFERENCE TO RELATED APPLICATIONS

This application is a national phase entry under 35 U.S.C. § 371 of International Patent Application PCT/FR2021/050386, filed Mar. 8, 2021, designating the United States of America and published as International Patent Publication WO 2021/260280 A1 on Dec. 30, 2021, which claims the benefit under Article 8 of the Patent Cooperation Treaty to French Patent Application Serial No. 2006481, filed Jun. 22, 2020.

### TECHNICAL FIELD

The field of the present disclosure is that of photonics, and more particularly the present disclosure relates to a photonic component comprising an integrated photonic chip that is joined to at least one optical part.

### BACKGROUND

The integrated photonic chips are components based on semiconductor materials, produced by means of technologies usually used in the field of microelectronics and microsystems. The chips can mix optical functionalities produced by active optical devices (lasers, modulators, photo detectors, etc.) and passive optical devices (waveguides, couplers, filters, etc.), and functionalities produced by conventional electronic devices. By way of illustration, a photonic component can implement an integrated photonic chip that comprises a transmitter-receiver and is coupled to an optical fiber of a telecommunications network.

In a particular implementation, shown in FIG. 1, the chip 1 comprises a plurality of waveguides 2 formed in a substrate 3, for example, made of silicon. The guides are arranged in a plane in parallel with a “main” surface of the chip 1, the plane being embedded under an encapsulation layer 4, for example, made of silicon dioxide. Optical couplers 5, also embedded, are arranged, respectively, at the ends of the waveguides 2. The waveguides 2 distribute the optical modes between the couplers 5 and the various active devices (lasers, modulators, photo detectors, etc.) and/or passive devices (filters, optical power splitters or combiners, etc.) of the chip. The couplers make it possible to propagate, in the form of beams 6, the optical modes propagating in the guides 2 from/toward the optical input-output areas Z arranged on the main face of the chip 1, via the encapsulation layer. These areas are generally arranged in lines or in a matrix, on the face.

In order to form the optical component, it is possible to equip the chip 1 with additional optical parts 7, 8, 9, 10, which make it possible, in particular, to couple the input-output areas Z of the chip 1 to a network of optical fibers 7. The fibers of the network are retained by a block 7a, for example, by means of V-shaped grooves formed in the block, in an arrangement that makes it possible to couple each input-output area Z of the chip to a fiber 7b of the network. This arrangement may be in lines or in a matrix, and the block 7a is joined to the photonic chip so as to position the fibers 7b and the input-output areas Z, where the beams emerge/arrive, so as to be facing one another optically. It is also possible to provide for assembly of other optical parts on the chip, such as a lens block 8 aiming to adjust the size of beams of the inputs/outputs Z to the size of the modes of the fibers 7b, a prism 9 for reorienting the beams and facilitating the assembly of the block 7a, or indeed an optical isolator 10. An example of such combinations is described in the document US20190146164.

The photonic chips are usually manufactured collectively on a semiconductor wafer, typically made of silicon. In addition, some optical parts are joined, respectively, to the chips before being cut from the wafer (“chip to wafer” type assembly) or after being cut (“chip to chip” type assembly), typically by means of automatic insertion equipment of components (“pick and place”). The document cited above notes that the networks of fibers may be arranged on the photonic chip by implementing passive or active alignment of the two elements relative to one another.

In the passive approach, alignment markers are made, respectively, on the chips and on the network of fibers. These markers are located by the insertion equipment of components, which joins the network of fibers onto the chip by seeking to align them visually, as best as possible. The equipment then fixes the two elements together using an adhesive material, for example, an epoxy glue. The insertion equipment of the prior art achieves an assembly precision of the order of +/−5 microns, sometimes slightly less, but without being able to achieve a precision of less than +/−1 micron. When it is intended for joining a network of fibers bearing fibers of which the mode size is less than or equal to 10 microns, in order for these to couple to inputs/outputs of couplers, the size of which is of the same order of magnitude, this precision of the order of +/−5 microns is insufficient. A precision of below 10% of the mode size is generally sought in order to ensure sufficient optical coupling, and thus less than +/−1 micron.

The active alignment approach makes it possible to overcome this problem of alignment precision of the fiber network. According to this approach, at least one input area and at least one output area of the chip are interconnected by a waveguide, the ends of which are equipped with couplers, associated, respectively, with the input area and with the output area. It is thus possible to propagate radiation from the optical input area toward the optical output area. The “alignment” input-output areas of the photonic chip are dedicated, so as to allow high-precision assembly of a fiberized optical part, such as a network of fibers. They generally do not have other uses in normal operation of the chip. Thus, in order to assemble a network of fibers, one fiber of the network, intended to couple optically with an alignment input area of the chip, is connected to an optical source outside of the chip. Similarly, one optical fiber of the network of fibers to be assembled, which fiber is intended to couple optically with an alignment output area of the photonic chip, is connected to an optical power meter. The source and the power meter may form part of the insertion equipment. The equipment manipulates the network of fibers so as to find the relative position thereof with respect to the chip, which makes it possible to maximize the optical power measured by the power meter, while the source provides a certain fixed power, the optimal position being that which places the alignment input-output areas so as to face fibers connected, respectively, to the source and to the power meter of the insertion equipment. Using this equipment, it is possible to ensure positioning of the two elements to +/−0.1 microns.

This approach requires the optical part, to be aligned with the photonic chip, to be “fiberized,” i.e., previously aligned and joined to a network of fibers. In the contrary case, it is necessary to fall back on the passive approach, the precision of which is limited.

The documents US 2016/334590 and U.S. Pat. No. 6,654,523 relate to the alignment of optical fibers with optical components.

### BRIEF SUMMARY

The main aim of the present disclosure is that of proposing an assembly method that overcomes this limitation. More particularly, the method aims to allow for precise assembly of an optical part on a photonic chip, the optical part not necessarily being fiberized. Another aim of the present disclosure is that of proposing a photonic chip that is designed so as to allow for the assembly method to be implemented in order to prepare a photonic component, the different elements of which are mutually aligned at a very high degree of accuracy.

In an effort to achieve the main aim, the subject matter of the present disclosure proposes a method for joining an optical part and a photonic chip, the optical part comprising a plurality of optical pathways to be aligned with a plurality of input-output areas arranged on a “main” face of the photonic chip, the assembly method comprising the following steps:
providing a photonic chip comprising at least one light source, at least one photo detector and, from the plurality of input-output areas, at least one alignment input-output optically associated with the light source and with the photo detector of the chip;
providing the optical part equipped with a reflector on at least one “alignment” pathway selected from the plurality of optical pathways, the alignment pathway being intended to be brought into correspondence with the alignment input-output area of the photonic chip;
activating the light source of the photonic chip so as to produce an alignment light beam in the region of the alignment input-output area, and measuring the signal provided by the photo detector of the photonic chip;
actively aligning the photonic chip and the optical part relative to one other by exploiting the measurement of the signal provided by the photo detector.

According to other advantageous and non-limiting features of the present disclosure, taken individually or in any technically possible combination:
the photonic chip comprises a supply pad and a measuring pad connected, respectively, to the light source and to the photo detector, and the method comprises a step aiming to contact the supply pad so as to activate the light source, and aiming to contact the measuring pad so as to measure the signal provided by the photo detector of the photonic chip;
the optical part is selected from the list formed of: a lens block, a network of fibers, a Faraday polarization rotator, a prism, an isolator, an assembly of at least two of the optical parts;
the reflector is a layer of a reflective material deposited on the optical part;
a Faraday polarization rotator is arranged in an optical path of the alignment beam between the photonic chip and the reflector;
the light source and the photo detector are optically associated with the alignment input-output via at least one waveguide and an optical coupler arranged at an end of the waveguide.

According to another aspect, the subject matter of the present disclosure proposes a photonic chip comprising a plurality of input-output areas arranged on a “main” face, the photonic chip comprising a light source, a photo detector and, from the plurality of input-outputs, at least one alignment input-output optically associated with the light source and with the photo detector of the chip.

According to other advantageous and non-limiting features of the present disclosure, taken individually or in any technically possible combination:
the light source and the photo detector are optically associated with the alignment input-output via at least one waveguide and an optical coupler arranged at an end of the waveguide;
the waveguide is a power splitter;
the optical coupler is a polarization-separating surface optical coupler, and the chip comprises a first waveguide between the light source and the optical coupler, and a second waveguide, separate from the first, between the photo detector and the optical coupler;
the photonic chip comprises a first waveguide between the light source and a first optical coupler, and a second waveguide, separate from the first, between the photo detector and a second optical coupler;
the photonic chip comprises an electrical supply pad for activating the light source, and a measuring pad for transferring the signal provided by the photo detector;
the photonic chip comprises a plurality of alignment input-outputs;
the main surface corresponds to a slice of the chip;
the light source is monolithically integrated.

According to yet another aspect, the present disclosure proposes a photonic component comprising a photonic chip as proposed above and at least one optical part comprising an optical alignment pathway from a plurality of optical pathways, the optical part being joined to the main surface of the photonic chip such that the optical alignment pathway is arranged so as to be in optical correspondence with the alignment input-output area of the chip.

According to other advantageous and non-limiting features of this aspect of the present disclosure, taken individually or in any technically possible combination:
the optical part is equipped with a reflector arranged on the alignment pathway;
the optical part is selected from the list formed of: a lens block, a network of fibers, a polarization rotator, a prism, an isolator, an assembly of at least two of the optical parts;
the optical part is an assembly comprising a Faraday rotator and the lens block;
the chip is designed to produce, in the region of the alignment input-output area, a beam having a specified mode size, and the optical part is joined to the photonic chip at a degree of precision of less than or equal to 10% of the specified mode size.

### BRIEF DESCRIPTION OF THE DRAWINGS

Other features and advantages of the present disclosure will become clear from the following detailed description of the present disclosure, with reference to the accompanying drawings, in which:

FIG. 1 shows a photonic chip from the prior art;

FIG. 2 is a schematic view of a main face of a photonic chip according to the present disclosure;

FIGS. 3A-3C show other configurations of photonic chips according to the present disclosure;

FIG. 4 shows an optical part that can be joined to a photonic chip according to an assembly method according to the present disclosure;

FIG. 5 shows an alternative architecture of a photonic chip according to the present disclosure;

FIG. 6 schematically shows an assembly method implementing the alternative architecture of FIG. 5;

FIGS. 7 and 8 schematically show other embodiments.

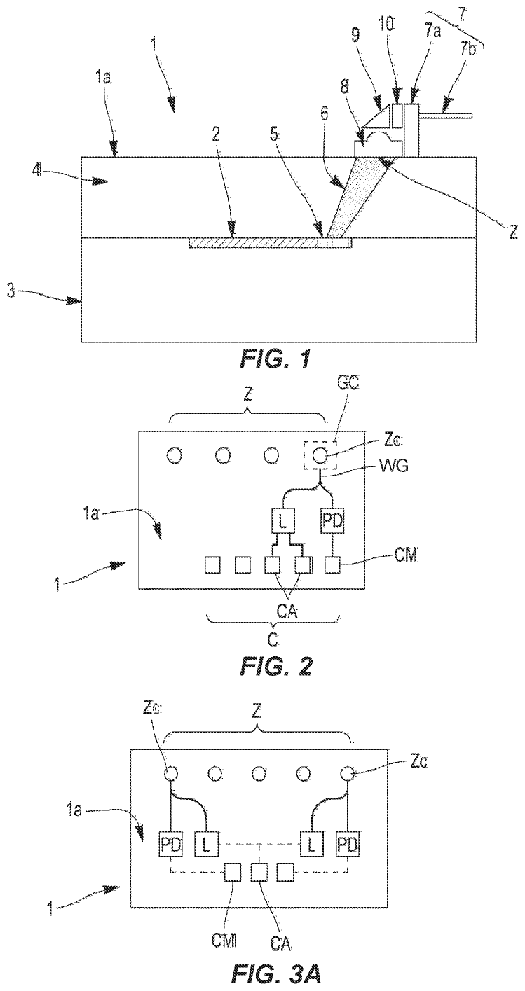

### DETAILED DESCRIPTION

Photonic Chip

With reference to FIG. 2, a photonic chip 1 is manufactured collectively, by conventional techniques in the field, on a material wafer, for example, a silicon-based wafer. The photonic chip 1 incorporates active devices such as lasers, demodulators, photo detectors associated with passive devices such as waveguides, optical couplers allowing for the chip 1 to be entirely functional. As has been set out in the introductory part of this disclosure, these devices are optically connected to one another and toward input-output areas Z arranged on a surface 1a of the chip 1, referred to in the remainder of this disclosure as the “main surface.” It is not necessary for all these elements to be monolithically integrated into the chip 1, and some of them, in particular, light sources, may be connected to a photonic chip and coupled to other elements of the chip, as will be illustrated with respect to the description of FIG. 8. “Photonic chip” denotes, in a general manner, the chip 1 optionally supplemented by these connected optical elements (in particular, a light source or a photodetector), making it at least in part functional.

The input-output areas correspond to portions of the main surface 1a of the chip 1, in the region of which light beams emerge or are injected. The main surface 1a may be the upper surface of the chip 1 on which electrical interconnection pads C are arranged, as is shown in FIG. 2, or a slice of the chip 1. For reasons of clarity in FIG. 2, this figure does not show all the functional devices of the chip 1, and this figure simply schematically shows the elements of the chip 1 that are necessary or useful for clear understanding of the present disclosure.

In this case, all the input-output areas Z (referred to more simply as “I/O areas” in the remainder of this description) are arranged in a line and comprise an alignment I/O area Zc. The photonic chip 1 comprises, embedded under an encapsulation layer, a light source L and a photo detector PD that are optically associated with the alignment I/O area Zc. For this purpose, a waveguide WG, in the example shown, a 1 to 2 power splitter, is also arranged in the embedded plane, so as to connect the source L and the photo detector PD to a surface optical coupler GC, in this case arranged perpendicularly to the alignment I/O area Zc.

The coupler GC allows for propagation, through the encapsulation layer and toward the alignment I/O area Zc, in the form of a light beam, of the radiation originating from the light source L. Vice versa, the coupler GC allows for coupling of an incident light beam, projecting on the alignment I/O area Zc, to the photo detector PD. In the example of FIG. 2, the waveguide WG is in the form of an optical splitter, having a first end associated with the optical coupler GC and two second ends associated, respectively, with the light source L and with the photo detector PD. In this configuration, light radiation emitted by the source L thus propagates in the waveguide WG and then through the encapsulation layer and toward the alignment I/O area Zc. Conversely, an incident light beam projecting in the region of the alignment I/O area couples to the waveguide WG via a grating coupler GC, and the radiation propagates in the waveguide WG both toward the light source L and toward the photo detector PD. In a general manner, all the elements optically associated with the alignment I/O area Zc form, in combination, an alignment circuit.

Continuing the description of FIG. 2, the photonic chip 1, taken by way of illustration, also comprises a plurality of electrical connection pads C, five connection pads in this figure. The pads C are flush with the main surface 1a of the chip 1, which makes it possible to electrically connect the chip 1 to other elements of the photonic component, for example, via wiring cables. The connection pads C are connected by means of a via and conductive tracks embedded in the active devices of the chip, for example, in order to supply them with electrical power or to provide/receive an electrical signal to be optically modulated/demodulated in the event of the photonic chip having such emission/reception functions. In the context of the present description, the connection pads C include at least one first pad CA, referred to as the supply pad, which makes it possible to supply the light source L with electrical power and to activate it such that it actually emits light radiation that is injected into the waveguide WG. The chip 1 also comprises at least one second connection pad, referred to as the measuring pad CM, which makes it possible to transfer the electrical signal, established by the photo detector PD, to the main surface 1a of the chip 1. The signal is representative of the power of the radiation propagating in the waveguide WG, originating from the optical coupler GC.

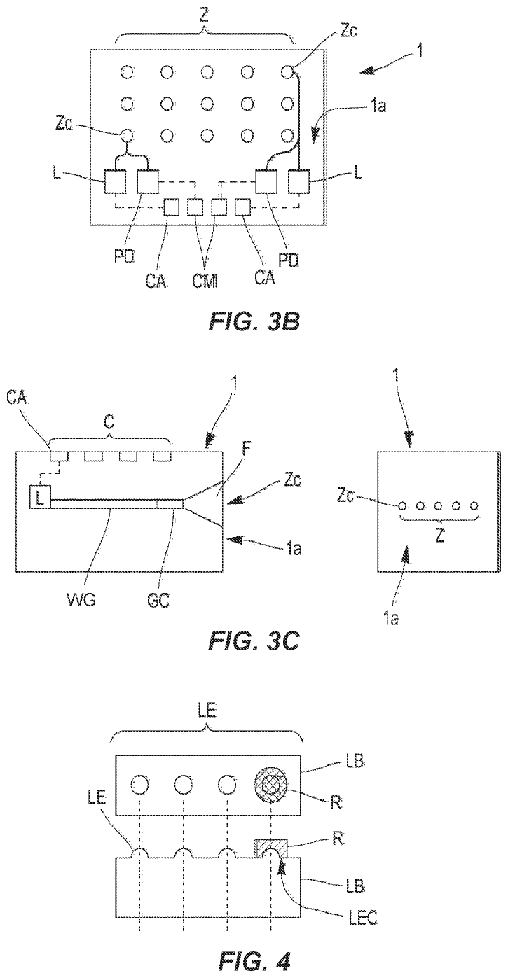

In the example shown, the photonic chip 1 is provided with a single alignment I/O area Zc optically associated with a light source L and with a photo detector PD. However, advantageously it would be possible to provide the chip 1, for reasons which will become apparent in the remainder of this description, with at least two alignment I/O areas Zc, each area Zc being associated with a light source L and a photo detector PD. FIG. 3A thus schematically shows a photonic chip 1 comprising a plurality of I/O areas Z arranged in a line on the main surface 1a of the chip 1. Two alignment I/O areas Zc form, respectively, end I/O areas of the line, and each of the two areas is associated with a light source L and with a photo detector PD. It is noted that, in an alternative arrangement to that of FIG. 3A, a single light source L may produce light radiation that is guided toward the plurality of alignment I/O areas Zc, for example, via a power splitter. The chip 1 comprises a supply pad CA that makes it possible to supply power to and to activate the or the two source(s) L, and a measuring pad CM that makes it possible to transfer an electrical signal combining the signals provided by the two photo detectors PD. It is possible, of course, to envisage other configurations, according to which each light source L is supplied by a dedicated supply pad CA, and/or each photo detector transfers its detected signal to a likewise dedicated measuring pad CM.

FIG. 3B shows another configuration comprising a plurality of alignment I/O areas Zc. In this configuration, the I/O areas Z are arranged in a matrix on the main surface 1a of the chip 1, and the alignment I/O areas Zc are in this case diagonally opposed to one another in the matrix.

In a general manner, when a plurality of alignment I/O areas Zc is provided, it is attempted to separate these from one another. They are thus not arranged in a manner juxtaposed from one another on the main surface.

FIG. 3C is a cross section and a view of the main surface 1a of a configuration in which the input-output areas Z are arranged on a slice of the chip 1, the slice thus forming the main surface 1a of the chip. In this case, the electrical connection pads C are generally arranged on the upper surface of the chip 1, which is different from the main surface 1a. Of course, this configuration comprises a light source L, a photo detector PD (not visible in the drawing), a waveguide WG, and a coupler GC, making it possible to propagate, in the form of a beam F, the optical mode propagating in the guide WG from/toward the alignment input-output area Zc. It is also possible to provide, in this configuration, a plurality of alignment input-output areas Zc.

It is noted that, in order to allow for the implementation of the assembly method, which is described below, it is possible to provide for joining the chip 1 in advance to a base, and for connecting, by wiring, the electrical connection pads C to corresponding pads of the base.

Assembly Method

A method for assembling an optical part and the chip 1 that has just been described is now set out. The assembly method forms part of a method for manufacturing a photonic component that benefits from alignment I/O areas and from alignment circuits integrated in the chip 1, which have just been described.

By way of example, the optical part is a lens block LB, i.e., a block bearing at least one lens, shown schematically in plan view and in cross section in FIG. 4 (the lenses of the lens block may be different from one another or identical). The part LB comprises a plurality of pathways, in this case passing through each lens LE of the block LB, which are intended to be brought into optical correspondence with the plurality of I/O areas Z of the photonic chip 1 during the assembly method. Thus, at least one alignment pathway emerges, defined here by an alignment lens LEc, intended to be brought into optical correspondence with the alignment I/O area Zc of the chip 1. It is noted that it is not necessary for each I/O area of the photonic chip to be brought into correspondence with a distinct pathway of the optical part. In particular, it is possible to provide for a plurality of I/O areas to all project in a single pathway of the optical part, for example, a large lens of the block LB.

Thus, bringing “into optical correspondence” means that an optical pathway of the optical part is aligned with an I/O area of the photonic chip 1 such that a light beam propagating through the assembly undergoes optical losses that are as reduced as possible. Preferably, an alignment of better than 10% of the size mode size of the beam, intended to propagate in a pathway, is sought.

In order to allow this, the alignment lens, and each alignment lens in the case where a plurality of alignment lenses is provided, may, according to the present disclosure, be designed to reflect light radiation that can be emitted by the light source L. In this respect, the reflection coefficient of the alignment lens in question may be greater than 0.1%, advantageously greater than 1%, even more advantageously greater than 5%.

According to another alternative, it is possible to provide for the alignment pathway, and each alignment pathway in the case where a plurality of pathways is provided, to be equipped with a reflector R made of a material that is reflective at the wavelength of the radiation emitted by the light source L. On the lens block LB of FIG. 4, the reflector R is formed of a metal layer arranged directly on, and in contact with, the alignment lens LEc of the pathway.

The assembly of the optical part LB is achieved by active alignment of the photonic chip 1 using the alignment circuit, for example, using an item of insertion equipment from the prior art, by activating the light source L of the photonic chip 1 so as to generate an alignment beam that propagates and reflects on one of the faces of the alignment lens, and by measuring the signal provided by the photo detector PD of the chip 1.

In a preliminary step of the assembly method, the insertion equipment, or complementary equipment connected to the insertion equipment, positions conductive tips of a measuring probe on the connection pads C of the chip 1, and, in particular, on the supply CA and measuring CM pads. The equipment is designed to provide, via contacts formed on the pads CA, CM, supply energy to the light source L, and to collect, on the measuring pad CM, the electrical signal delivered by the photo detector PD. The power supply is provided, and the measurement is collected, in a continuous manner during the active alignment step that follows.

During the following alignment step, the insertion equipment “roughly” positions the optical part LB relative to the chip, in an assembly position aiming to bring the plurality of pathways of the optical part into correspondence with the plurality of I/O areas Z of the chip 1. The rough assembly can be assisted by alignment markers formed on the chip 1 and/or on the optical part, as has been described in the introduction of this disclosure.

The radiation emitted by the light source L propagates in the waveguide WG toward the optical coupler GC and emerges from the chip 1 in the region of the alignment I/O area Zc. A portion of the emerging beam propagates in the alignment pathway of the optical part. Since the alignment is rough and imperfect, the coupling between the chip 1 and the optical part also is, and thus only a portion of the emerging beam actually propagates in the alignment pathway. The portion is reflected by the alignment lens (or by the reflector arranged on the lens, if this is considered) and reinjected, also in part, into the photonic chip 1 in the region of the alignment I/O area Zc in order to couple to the waveguide WG. A portion of the coupled radiation is directed toward the photo detector PD, and the optical power received by the device forms a measuring signal that is transferred to the measuring pad CM. It is understood that, the more precise the alignment between the alignment I/O area Zc and the alignment pathway, the greater the power reflected toward the photo detector PD will be. The electrical signal provided by the device is thus representative of the quality of the alignment of the two elements. It is also understood that, in order to ensure precise positioning of the optical part relative to the chip 1, it is advantageous to have a plurality of alignment pathways and a plurality of alignment circuits in the chip 1, in order to be able to take into account the alignment gaps in translation and in rotation.

In all cases, the insertion equipment can make use of the signal provided by the photo detector PD for precise active alignment of the two elements relative to one another. In order to achieve this, the equipment finally shifts the optical part (and/or the chip 1) in translation according to various directions in the plane defined by the main surface of the chip 1, and in rotation about an axis perpendicular to the main surface 1a, while observing the development of the signal provided by the photo detector PD and collected on the measuring pad CM. The fixing position of the optical part on the photonic chip 1 is that which maximizes the value of the signal. Once the position is determined, the optical part can be firmly fixed to the chip 1, for example, using an epoxy glue, as is well known per se.

At the end of this step, which can optionally be repeated if a plurality of optical parts has to be joined to the photonic chip 1, a photonic component is achieved comprising the photonic chip 1 and the optical part, the lens block LB in the example described, the optical part being joined to the main surface 1a of the photonic chip 1 such that the optical alignment pathway is arranged so as to be in optical correspondence with the alignment I/O area Zc of the chip 1. This, of course, leads to all the optical pathways of the optical part being brought into correspondence with the I/O areas Z of the chip. The quality of this correspondence can be improved by providing a plurality of alignment circuits in the chip 1, and an optical part comprising as many alignment pathways equipped with their reflectors, as has been mentioned above. It is thus possible to achieve an alignment precision of much less than 10% of the mode size of the light beam produce by the source L in the region of the alignment I/O area Zc.

The approach that has just been set out is in no way limited to the assembly of the lens block LB that has been used by way of example. It can apply to any optical part to be joined to the photonic chip 1 in order to complete and form a functional photonic component. It may be, in particular, besides the lens block, a network of fibers, a Faraday polarization rotator, a prism, an isolator, a polarizer. It may be a plurality of the optical parts that are previously joined to one another. It will be noted that some of these parts (plug, rotator, etc.) do not require precise alignment relative to the chip 1 or other optical parts, and in this case the assembly of the parts can be achieved without using the alignment circuit of the chip 1, for example, by means of passive assembly. In a general manner, an assembly method according to the present disclosure can mix a plurality of assembly approaches, it being possible for some optical parts to be joined to the chip 1 without taking advantage of the alignment circuit.

In all cases where it is desirable to take advantage of the alignment circuit of the chip 1, it will be provided to consider an alignment lens capable of reflecting, in part, the light radiation emitted by the light source L. Alternatively, and as described above in the disclosure, it is possible to provide for a reflector R to be arranged on the alignment pathway of the optical part, in order to be able to implement the assembly method that has just been set out. In the case of a network of fibers, the reflector R could, for example, be arranged in a V-shaped groove of the block that holds the fibers, in place of such a fiber or by placing therein a fiber comprising a reflector at the end thereof.

It is noted that this assembly method is in no way limited to a fiberized optical part, as is the case in the active assembly method of the prior art, which is very advantageous.

When a plurality of optical parts are to be joined onto the same chip 1, it is possible to provide a plurality of alignment circuits in order to make it possible to implement the assembly method successively for each of the parts, each alignment circuit being dedicated to the assembly of one part. This is, in particular, the case when the alignment lens is designed to reflect, or when a reflector is formed directly on the part to be joined, and is not removed following fixing of the optical part onto the chip.

When a reflector is considered, it is possible to envisage that this is not formed in a definitive manner on the optical part. It may thus be a reflective paste arranged on the part so as to shape to the part, for example, to the shape of the lens LBc of the alignment pathway, when the part is a lens block LB. The paste may be eliminated from the optical part at the end of the assembly method. In this case, it is possible to re-use the same alignment circuit in order to successively align a plurality of optical parts.

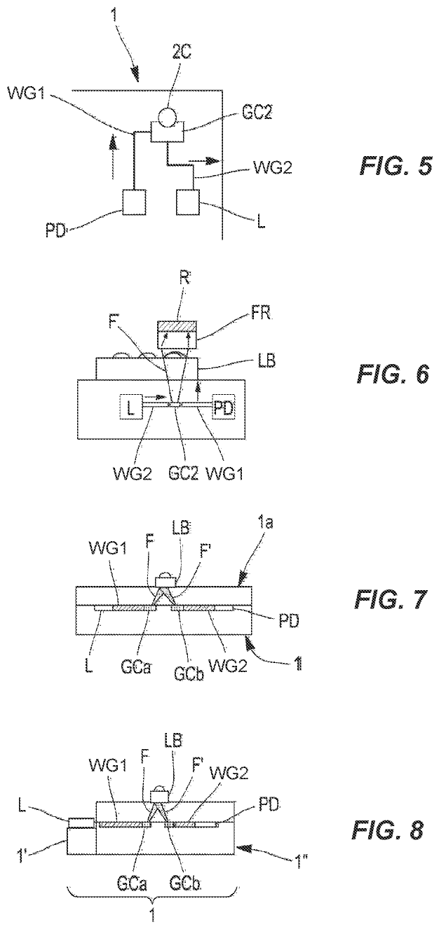

With reference to FIGS. 5 and 6, a photonic chip 1 comprising an alternative architecture to that proposed in FIG. 2 is now set out, in the case of which chip the photonic chip of the light radiation F reflected toward the source L may, in some cases, affect its functioning. In order to avoid this, it is possible to choose to associate the alignment I/O area Zc with the light source L and with the photo detector PD by means of two separate waveguides WG1, WG2, which meet in the region of a polarization-separating surface optical coupler GC2. In this alternative architecture, a first waveguide WG1 optically associates the photo detector PD with the coupler GC2, and a second waveguide WG2, separate from the first, associates the light source L with the coupler GC2. The latter makes it possible to selectively propagate the light radiation between the two waveguides WG1 and WG2 and the alignment I/O area Zc. A 2D grating coupler of this kind is described, in particular, in the publication by Taillaert, Dirk, et al. “A Compact Two-Dimensional Grating Coupler Used as a Polarization Splitter.” IEEE PHOTONICS TECHNOLOGY LETTERS 15.9 (2003): 1249. It is made up of a superposition of two 1D coupler gratings, and each orthogonal polarization of radiation projected onto the coupler is directed toward separate waveguides WG1, WG2. When the assembly method makes use of such a configuration of the chip 1, and in order to allow the actual coupling of the radiation reflected by the alignment lens into the waveguide associated with the photo detector, it is provided for a Faraday polarization rotator FR to be inserted into the optical path of the alignment beam, as is shown in FIG. 6. The light originating from the light source L is in a first polarization TE, it is turned by 45° through the rotator, reflected by the alignment lens of the optical part during assembly, then turned again on its return path in order to have a second polarization TM perpendicular to the first polarization TE. The light reflected in the second polarization TM is directed toward the photo detector PD by means of the polarization-separating surface optical coupler GC2. In the case of slice-wise coupling, the slice then forming the main surface 1a, it is possible to provide a beam splitter in order to allow for redirection of the light reflected in the second polarization, toward the photo detector PD.

FIGS. 7 and 8 are schematic illustrations showing other embodiments. In the embodiment of FIG. 7, a first coupler GCa at the end of a first waveguide WG1 directs a mode, originating from a source L monolithically integrated into the chip 1, toward the I/O areas via a beam F. The beam F has a non-zero angle of incidence with respect to these areas Z, i.e., it is projected onto the areas according to a direction that is not perpendicular to the main surface 1a. A second coupler GCb, separate from the first, is provided for collecting the reflected beam F′ and propagating it in a second waveguide WG2 associated with the photo detector PD. FIG. 7 also shows a lens block LB arranged on the main surface 1a, facing the I/O areas.

FIG. 8 proposes a configuration similar to that of FIG. 7, in which the photonic chip 1 comprises a light source L that is not monolithically integrated. The photonic chip is thus formed by a first chip 1′ comprising the light source joined to a second chip 1″ comprising the other optical elements, as described with reference to FIG. 7.

Of course, the present disclosure is not limited to the embodiments described, and it is possible to add variants thereto, without extending beyond the scope of the invention as defined by the claims.

1. Method A method for assembling an optical part and a photonic chip, the optical part, formed by a lens block provided with a plurality of lenses and forming a plurality of optical pathways to be aligned with a plurality of input-output areas arranged on a “main” face of the photonic chip, the method comprising:
providing a photonic chip comprising at least one light source, at least one photo detector and, from the plurality of input-output areas, at least one alignment input-output optically associated with the light source and with the photo detector of the chip;
providing the optical part, at least one lens of the plurality of lenses comprising an alignment lens forming an alignment pathway selected from the plurality of optical pathways, the alignment pathway configured to be brought into correspondence with the alignment input-output area of the photonic chip, the alignment lens being designed such that, when the alignment lens is in correspondence with the alignment input-output, the alignment lens will reflect at least a portion of a light beam produced by the light source, toward the photo detector;
activating the light source of the photonic chip to produce an alignment light beam in the region of the alignment input-output area, and measuring the signal provided by the photo detector of the photonic chip; and
actively aligning the photonic chip and the optical part relative to one other responsive to the measurement of the signal provided by the photo detector.

2. The method of claim 1, wherein the photo detector comprises a supply pad and a measuring pad connected, respectively, to the light source and to the photo detector, and the method further comprises contacting the supply pad so as to activate the light source, and contacting the measuring pad so as to measure the signal provided by the photo detector of the photonic chip.

3. The method of claim 1, wherein the alignment lens comprises a reflector arranged to reflect at least a portion of a light beam produced by the light source, toward the photo detector when the alignment lens is in correspondence with the alignment input-output.

4. The method of claim 1, further comprising a Faraday polarization rotator is arranged in an optical path of the alignment light beam between the photonic chip and the reflector.

5. The method of claim 1, wherein the light source and the photo detector are optically associated with the alignment input-output via at least one waveguide and an optical coupler arranged at an end of the waveguide.

6. A photonic component comprising:
a photonic chip comprising a plurality of input-output areas arranged on a main face of the photonic chip, the photonic chip comprising a light source, a photo detector and, from the plurality of input-outputs, at least one alignment input-output optically associated with the light source and with the photo detector of the chip; and
at least one photonic part arranged on the main face, the photonic part comprising a lens block including a plurality of lenses and forming a plurality of optical pathways, each in correspondence with an input-output of the plurality of input-output areas, at least one lens from of the plurality of lenses comprising an alignment lens in correspondence with an alignment pathway, the alignment lens being designed to reflect at least a portion of a light beam produced by the light source, toward the photo detector.

7. The photonic component of claim 6, wherein the light source and the photo detector are optically associated with the alignment input-output via at least one waveguide and at least one optical coupler arranged at an end of the waveguide.

8. The photonic component of claim 7, wherein the waveguide is a power splitter.

9. The photonic component of claim 7, wherein the optical coupler is a polarization-separating surface optical coupler, and the photonic chip comprises a first waveguide between the photo detector and the optical coupler, and a second waveguide, separate from the first, between the light source and the optical coupler.

10. The photonic component of claim 7, wherein the photonic chip comprises a first waveguide between the light source and a first optical coupler, and a second waveguide, separate from the first, between the photo detector and a second optical coupler.

11. The photonic component of claim 6, wherein the photonic chip comprises an electrical supply pad configured for activating the light source, and a measuring pad configured for transferring the signal provided by the photo detector.

12. The photonic component of claim 6, wherein the photonic chip comprises a plurality of alignment input-outputs.

13. The photonic component of claim 6, wherein the main surface corresponds to a slice of the chip.

14. The photonic component of claim 6, wherein the light source is integrated monolithically.

15. The photonic component of claim 6, wherein the optical part is equipped with a reflector-ER arranged on the alignment pathway.

16. The photonic component of claim 6, wherein the optical part is an assembly comprising a Faraday rotator and the lens block.

17. The photonic component of claim 6, wherein the chip is designed to produce, in the region of the alignment input-output area, a beam having a specified mode size, and wherein the optical part is joined to the photonic chip at a degree of precision of less than or equal to 10% of the specified mode size.

18. The method of claim 3, wherein the reflector is selected to comprise a layer of reflective material deposited on the alignment lens.
